(19) United States
(12) Patent Application Publication
(10) Pub. No.: US 2014/0265073 A1
(43) Pub. Date: Sep. 18, 2014

(54) ELASTOMERIC BUSHING ASSEMBLY WITH INTERCHANGEABLE BAR PIN

(71) Applicant: THE PULLMAN COMPANY, Milan, OH (US)

(72) Inventor: Brent Johnston, Milan, OH (US)

(73) Assignee: The Pullman Company, Milan, OH (US)

(21) Appl. No.: 13/862,763

(22) Filed: Apr. 15, 2013

Related U.S. Application Data
(60) Provisional application No. 61/786,670, filed on Mar. 15, 2013.

(51) Int. Cl. F16F 1/38

(52) U.S. Cl. CPC F16F 1/3863
USPC 267/140.4

(57) ABSTRACT

The present disclosure provides an elastomeric bushing assembly that includes a multi-piece inner component. The inner component is formed from a standard bar pin and an inner tube. The bar pin is inserted into the inner tube to form the multi-piece inner component. By utilizing different sizes of inner tubes, both standard and heavy duty bushing assemblies can be manufactured using a common bar pin.

### CROSS-REFERENCE TO RELATED APPLICATIONS

This application claims the benefit of U.S. Provisional Application No. 61/786,670, filed on Mar. 15, 2013. The entire disclosure of the above application is incorporated herein by reference.

### FIELD

The present disclosure relates to articulating bushing assemblies. More specifically, the present disclosure relates to elastomeric bushing assemblies that incorporate an interchangeable bar pin.

### BACKGROUND

This section provides background information related to the present disclosure which is not necessarily prior art.

Applications for an elastomeric bushing assembly include, but are not limited to, torsion bars, linear torque rods, V-shaped torque rods, leaf springs, independent suspension control arms and other suspension control devices. These and other applications are used on a wide variety of vehicles such as automobiles, trucks, buses, off-highway vehicles, rail cars and other transportation applications.

Elastomeric bushing assemblies typically include an outer metal, an inner metal and an elastomeric bushing disposed between the outer metal and the inner metal. The outer metal can be a tubular member which is a part of the component that incorporates the elastomeric bushing assemblies or the outer metal can be a separate tubular member that is designed to be assembled to the component that incorporates the elastomeric bushing assembly by being press fit or otherwise attached to the component.

The inner metal is typically a solid tubular member which is adapted to be secured to the vehicle and/or suspension member of the application which includes the component that incorporates the elastomeric bushing assembly. One example of an inner metal is a bar pin that has a cylindrical center section and a cylindrical end section disposed at both ends of the center section. The cylindrical end sections extend out from the center section of the outer metal and each cylindrical end section defines a groove which is used to secure the elastomeric bushing assembly to the vehicle and/or the suspension member of the application.

The solid bar pin can be machined from bar stock, it can be cast, it can be forged or it can be manufactured by other methods in the art. If necessary, the formed solid bar pin can be machined at the flat sections and/or the center section to complete the manufacture of the bar pin.

Typically, bushing assemblies are manufactured in two families, a standard duty bushing assembly and a heavy duty bushing assembly. These two bushing assemblies are similar when it comes to the cylindrical end portion of the bar pin that extends out from each end of a center section that is disposed within the elastomeric member but the diameter of the center section within the elastomeric member and the diameter of the outer metal are larger for the heavy duty bushing assemblies. This dual design concept has the following disadvantages. First, the bar pin extensions and the center section have to be machined as a single piece solid component. Second, each design of the bushing assembly (standard and heavy duty) must have its own unique bar pin which requires the manufacture and stocking of two separate pins rather than one high volume manufactured pin. Third, typically the elastomeric bushing is molded directly to the bar pin and multiple pin diameters can cause difficulties in the assembly lines for the bushing assemblies. Finally, because of the two different sized center sections, each bushing assembly (standard and heavy duty) require a dedicated mold for the elastomeric bushing.

### SUMMARY

This section provides a general summary of the disclosure, and is not a comprehensive disclosure of its full scope or all of its features.

The present disclosure provides an elastomeric bushing assembly that incorporates an interchangeable inner metal. The interchangeable inner metal can take the form of a two-piece bar pin which includes a standard sized bar pin and a cylindrical tube which adapts the standard sized bar pin to a specific application. By having multiple sized cylinder tubes, multiple applications can utilize the same bar pin.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of elastomeric bushing assemblies incorporating the multi-piece inner metal in accordance with the present disclosure;

FIG. 2 is a cross-sectional view of one of the elastomeric bushing assembly illustrated in FIG. 1; and,

FIG. 3 is a cross-sectional view of the other elastomeric bushing illustrated in FIG. 1.

Corresponding reference numerals indicate corresponding parts throughout the several views of the drawings.

### DETAILED DESCRIPTION

Example embodiments will now be described more fully with reference to the accompanying drawings.

Referring to FIGS. 1-3, a pair of elastomeric bushing assemblies 10 and 20 in accordance with the present disclosure, are illustrated. Elastomeric bushing assembly 10 comprises a bar pin 12, an inner tube 14, an elastomeric member 16 and an outer tube 18. Elastomeric bushing assembly 20 comprises bar pin 12, an inner tube 24, an elastomeric member 26 and an outer tube 28.

Bar pin 12 is a cylindrical member having a constant outside diameter over its entire length. At each end of bar pin 12, a groove 40 is formed which is used to fasten bar pin 12 and thus elastomeric bushing assemblies 10 and 20 to the vehicle. As illustrated, both elastomeric bushing assembly 10 and elastomeric bushing assembly 20 share the common bar pin 12. Grooves 40 define means for attaching bar pin 12 to the vehicle.

Inner tube 14 is a cylindrical tube within which bar pin 12 is located. Inner tube 14 has a constant outside diameter over its entire length and a constant inner diameter over its entire length. The inside diameter of inner tube 14 is less than the outside diameter of bar pin 12 such that a press fit exists between inner tube 14 and bar pin 12.

Elastomeric member 16 is an elastomer that is disposed between inner tube 14 and outer tube 18. Elastomeric member 16 can be molded over inner tube 14 and then pressed into outer tube 18. The outside diameter of elastomeric member 16 after being molded over inner tube 14 is larger than the inside diameter of outer tube 18 such that a predetermined amount of compression is applied to elastomeric member 16 after elastomeric member 16 is pressed into outer tube 18. Elastomeric member 16 could be molded into outer tube 18 and then inner tube 14 could be pressed into the inside diameter of elastomeric member 16. In this case, the as molded inside diameter of elastomeric member 16 would be less than the outside diameter of inner tube 14 such that a predetermined amount of compression is applied to elastomeric member 16 after inner tube 14 is pressed into elastomeric member 16. Elastomeric member 16 can be bonded to one or both of inner tube 14 and outer tube 18.

Outer tube 18 is a cylindrical tube which fully encircles elastomeric member 16. Outer tube 18 has a constant outside diameter and a constant inside diameter in the area immediately over elastomeric member 16. Each end of outer tube 18 is curled over to define an annular wall 42 which helps to encapsulate elastomeric member 16.

Inner tube 24 is a cylindrical tube within which bar pin 12 is located. Inner tube 24 has a constant outside diameter over its entire length and a constant inner diameter over its entire length. The inside diameter of inner tube 24 is less than the outside diameter of bar pin 12 such that a press fit exists between inner tube 24 and bar pin 12. Thus, inner tube 14 and inner tube 24 may have the same inside diameter.

Elastomeric member 26 is an elastomer that is disposed between inner tube 24 and outer tube 28. Elastomeric member 26 can be molded over inner tube 24 and then pressed into outer tube 28. The outside diameter of elastomeric member 26 after being molded over inner tube 24 is larger than the inside diameter of outer tube 28 such that a predetermined amount of compression is applied to elastomeric member 26 after elastomeric member 26 is pressed into outer tube 28. Elastomeric member 26 could be molded into outer tube 28 and then inner tube 24 could be pressed into the inside diameter of elastomeric member 26. In this case, the as molded inside diameter of elastomeric member 26 would be less than the outside diameter of inner tube 24 such that a predetermined amount of compression is applied to elastomeric member 26 after inner tube 24 is pressed into elastomeric member 26. Elastomeric member 26 can be bonded to one or both of inner tube 24 and outer tube 28.

Outer tube 28 is a cylindrical tube which fully encircles elastomeric member 26. Outer tube 28 has a constant outside diameter and a constant inside diameter in the area immediately over elastomeric member 26. Each end of outer tube 28 is curled over to define an annular wall 52 which helps to encapsulate elastomeric member 26.

The present disclosure allows for multiple families of parts to share a common component such as bar pin 12. This allows the consolidation of a large number of components into fewer components with higher volumes for each component. This concept also simplifies the design to eliminate much of the machining, allows for shorter mold times with more pieces per heat and eliminates some of the processing issues the current designs have. The elastomeric bushing assemblies of the present disclosure lower the overall cost while keeping the performance of the elastomeric bushing assemblies the same or better than the current designs while maintaining the overall package size of the elastomeric bushing assemblies to allow them to be direct replacements to the current design.

Inner tube 14 and inner tube 24 may be designed with the same inside diameter but inner tube 24 has a larger outside diameter than inner tube 14 to represent the barrel outside diameters of the one piece fully machined bar pins used to make the current standard and heavy duty bushings. Inner tube 14 and inner tube 24 can each be processed as separate components to make a finished standard duty cartridge 60 and a finished heavy duty cartridge 62. Standard duty cartridge 60 comprises bar pin 12, inner tube 14, elastomeric member 16 and outer tube 18. Heavy duty cartridge 62 comprises bar pin 12, inner tube 24, elastomeric member 26 and outer tube 28. Bar pin 12, with a given spacing between grooves 40, can then be pressed into either standard duty cartridge 60 or heavy duty cartridge 62 to create elastomeric bushing assembly 10 and elastomeric bushing assembly 20, respectively.

The design described in the disclosure allows the current design of bar pin 12 to be built from two components, inner tube 14 or inner tube 24 that represents the pin barrel outside diameter and a straight constant outside diameter bar pin 12 sized to the outside diameter of the pin extension or the current design. With this concept, elastomeric member 16 and elastomeric member 26 can be molded directly to inner tube 14 and inner tube 24, respectively. In the current design, the elastomeric member is molded directly to the fully machined bar pin. This allows inner tube 14 and inner tube 24 to be processed through manufacturing into finished standard duty cartridge 60 and finished heavy duty cartridge 62, respectively without bar pin 12. Bar pin 12 can then be pressed into standard duty cartridge 60 or heavy duty cartridge 62. Inner tube 14 and/or inner tube 24 can be designed with an inside diameter and an outside diameter such that no machining of inner tubes 14, 24 is required or inner tube 14 and/or inner tube 24 can be machined. Bar pin 12 can be designed such that as rolled bar stock can be used thus eliminating any machining other than grooves 40 or bar pin 12 can be designed to be machined over its entire length.

Inner tube 14 and inner tube 24 may be a metal component, a plastic component or any other material which meets the performance requirements for elastomeric bushing assembly 10 and elastomeric bushing assembly 20, respectfully.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An elastomeric bushing assembly comprising:
an outer metal;
an inner metal;
an elastomeric bushing disposed between said outer metal and said inner metal; wherein said inner metal comprises:
a first component; and
a second component, separate from said first component, fully encircling said first component to form said inner metal.

2. The elastomeric bushing assembly according to claim 1, wherein said first component is a bar pin, said bar pin having first means for attaching said bar pin to a vehicle at a first end and second means for attaching said bar pin to said vehicle at a second end, said bar pin having a constant outside diameter between said first and second attaching means.

3. The elastomeric bushing assembly according to claim 2, wherein said second component is a tube.

4. The elastomeric bushing assembly according to claim 3, wherein said tube has a constant inner diameter and a constant outer diameter over an entire length of said tube.

5. The elastomeric bushing assembly according to claim 3, wherein said bar pin is press fit within said tube.

6. The elastomeric bushing assembly according to claim 1, wherein said second component is a tube.

7. The elastomeric bushing assembly according to claim 6, wherein said tube has a constant inner diameter and a constant outer diameter over an entire length of said tube.

8. The elastomeric bushing assembly according to claim 6, wherein said first component is press fit within said tube.

9. An elastomeric bushing assembly comprising:
a tubular outer metal;
a tubular inner metal;
an elastomeric bushing disposed between said outer metal and said inner metal;
a bar pin disposed within said tubular inner metal;
first means for attaching said elastomeric bushing to a vehicle disposed at a first end of said bar pin; and
second means for attaching said elastomeric bushing to said vehicle disposed at a second end of said bar pin opposite to said first side of said bar pin.

10. The elastomeric bushing assembly according to claim 9, wherein said bar pin has a constant diameter between said first and second attaching means.

11. The elastomeric bushing assembly according to claim 10, wherein said tubular inner metal has a constant inside diameter and a constant outside diameter over an entire length of said tubular inner metal.

12. The elastomeric bushing assembly according to claim 10, wherein said bar pin is press fit within said tubular inner metal.

13. The elastomeric bushing assembly according to claim 9, wherein said tubular inner metal has a constant inside diameter and a constant outside diameter over an entire length of said tubular inner metal.

14. The elastomeric bushing assembly according to claim 9, wherein said bar pin is press fit within said tubular inner metal.
